(19) United States
(12) Patent Application Publication
(10) Pub. No.: US 2005/0258604 A1
(43) Pub. Date: Nov. 24, 2005

(54) Collet chuck or clamping sleeve

(76) Inventors: Konrad Abt, Reigoldswil (CH); Robi Karmann, Basel (CH); Marcel Wertli, Holstein (CH)

Correspondence Address: HOFFMANN & BARON, LLP, 6900 JERICHO TURNPIKE, SYOSSET, NY, 11791, US

(21) Appl. No.: 11/131,060

(22) Filed: May 17, 2005

(30) Foreign Application Priority Data
May 18, 2004 (CH) CH-00868/04

(51) Int. Cl. B23B 31/12

(52) U.S. Cl. 279/43.2

(57) ABSTRACT

In a collet chuck or clamping sleeve having a receiving bore for a tool or workpiece, a plurality of clearing bores which are parallel to the axis and offset at equal axial distances and uniform angles and which are connected to the receiving bore by connecting slots are arranged around the receiving bore. In a slotted collet chuck, the clearing bores are each arranged in the segments formed by the slots. The slots extending from the outer casing radially inwards end at a distance from the receiving bore. For the production of such a collet chuck, a plurality of clearing bores which are parallel to the axis and offset at equal axial distances and uniform angles are made around the axis. An erosion wire is threaded through one of them and then a connecting slot to the axis, a coaxial receiving bore and from there connecting slots to the further clearing bores are produced in succession.

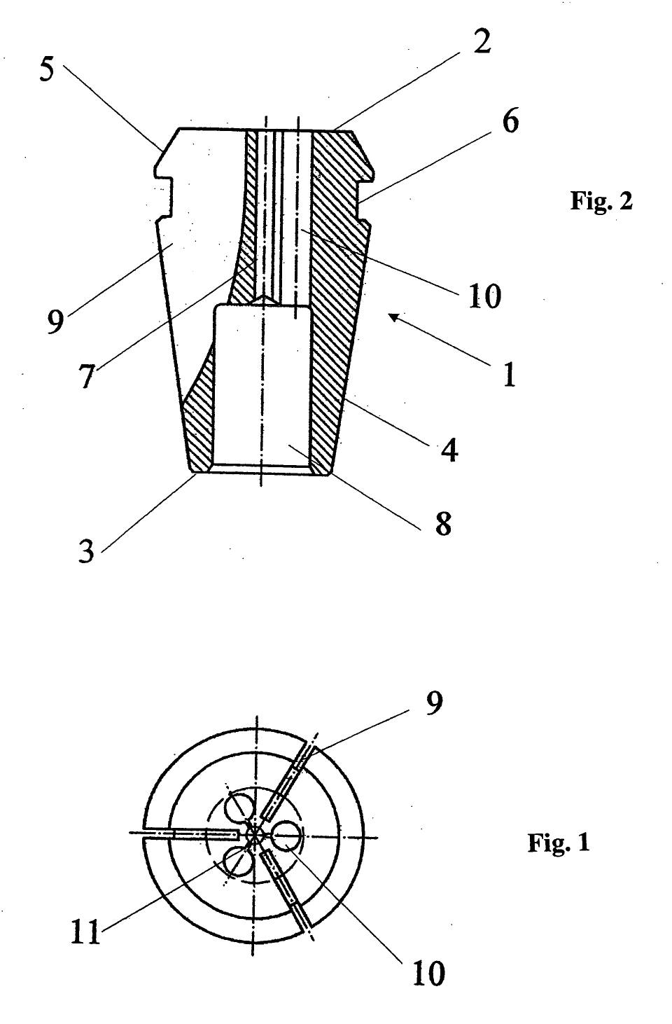

The invention relates to a collet chuck or clamping sleeve having a receiving bore for a tool or workpiece.

Conical collet chucks having different cone angles are usually provided with slots which extend along axial planes, offset at uniform angles, from the receiving bore to the conical outer casing. In the axial direction, the slots extend alternately from the two end faces, in each case over a part, for example 80%, of the axial length of the collet chuck. This gives rise to segments which can move radially with respect to the receiving bore. If these collet chucks are pressed or drawn into a corresponding conical receptacle, radial forces are applied by the forces generated, from the receptacle via the segments of the collet chuck to the shaft to be clamped.

In addition to these customary conical collet chucks, other clamps and clamping sleeves and correspondingly different force generations are known, for example hydroexpansion clamps in which a membrane in the interior of the receiving bore is expanded by means of oil pressure; expansion clamps having a function similar to that of the hydroexpansion clamps but with a solid instead of the oil; shrink holders in which the receiving bore expands as a result of the heating of the material and then shrinks again on cooling and thus generates the force; annular receptacle having a cylindrical receiving bore for the clamping sleeve and conical outer casing over which a likewise conical ring is pressed and radial compression thus takes place.

The slots in the slotted collet chucks are usually milled. The receiving bore for tool shafts is either likewise produced by machining or, particularly in the case of very small diameters, produced by means of wire erosion following the milling of the slots, starting from the latter. It has proved to be disadvantageous that existing material stresses relax after complete separation of the web between the slots and the receiving bore and lead to the collapse or other deformations, resulting in eccentricity.

It is therefore the object of the invention to provide a production possibility which leads in particular to better concentricity properties.

According to the invention, this is achieved by arranging, around the receiving bore, a plurality of clearing bores which are parallel to the axis and offset at equal axial distances and uniform angles and which are connected to the receiving bore by connecting slots. In the case of slotted collet chucks, the clearing bores are each arranged in the segments formed by the slots. Preferably, the slots of slotted collet chucks which extend from the outer casing radially inwards end at a distance from the receiving bore.

Owing to the material remaining between the slots and the receiving bore, a sort of bridge, these collet chucks are particularly stable both during manufacture and in use. The radial flexibility required for clamping a tool shaft is achieved by the clearing bores connected to the receiving bore by connecting slots.

The combination of the slots, which are not continuous in the radial direction, with the respective clearing bores located inbetween can be used in the case of various collet chuck types, for example in the case of collet chucks of type DIN 6499 having an 8° cone and the opposite angle of 30°, as well as collet chucks of type DIN 6388 having a cone of cone ratio 10:1 and the opposite angle of 30°, in the case of draw-back collet chucks and push-out collet chucks having a single cone or double cone with different cone angles, and also in the case of cylindrical clamping sleeves.

A preferred embodiment of the invention is described below with reference to the drawing.

The FIGURE shows a conical slotted collet chuck in plan view onto the end face on the tool side and an axial section along the line A-A. Its outer surface is characterized by a lateral surface 1, a flat end face 2 on the tool side and a flat end face 3 on the machine side. The lateral surface has a flat cone surface 4 which corresponds to the customary inner cone of a receptacle. A steeper cone surface 5 serves for application of a clamping nut. In between is a customary annular groove 6 for engaging an extracting lobe of a clamping nut.

A coaxial receiving bore 7 serves for receiving a tool shaft. Owing to the known difficulties with an excessively long bore having a small diameter, a coaxial bore 8 having a large diameter extends from the machine side over about half the length of the collet chuck so that the receiving bore 7 likewise extends only over half the length. Three slots 9 offset at angles of 120° extend from the lateral surface 1 in the axial direction over about three quarters of the total axial length and in the radial direction over not more than about 90% of the distance between lateral surface and receiving bore.

Clearing bores 10 parallel to the axis are offset at angles of in each case 60° relative to the slots and 120° relative to one another. Connecting slots 11, which are produced during the production of the receiving bore, are formed between the clearing bores and the receiving bore.

Of course, it is possible to dispense with the wide bore 8. In this case, the receiving bore, the clearing bores and the connecting slots extend over the total length of the collet chuck.

During production, one of the clearing bores serves as a threading bore for the wire erosion of the receiving bore and of the connecting slots. By means of this method, it is possible to produce very small receiving bores as well as large bores with precise concentricity.

Instead of three segments formed by three slots 9 and having a corresponding number of clearing bores and connecting slots, as in the present embodiment, a larger number of slots, segments, etc. is also possible in the same manner.

The collet chucks produced in this manner have a number of advantages over conventional comparable collet chucks. The collet chuck remains self-contained so that no deformation arises through released residual stresses. Owing to the clearing bores and the connecting slots thereof to the receiving bore between the chuck segments, the required radial flexibility, which permits clamping, is achieved. The clearing bores and the connecting slots give rise to a sort of bridge, which is located between the segments. When the segments are pressed radially inwards as a result of drawing in or pressing in the collet chuck, this pressure is transmitted by means of this bridge to the tool shaft to be clamped.

1. Collet chuck or clamping sleeve having a receiving bore for a tool or workpiece, wherein a plurality of clearing bores which are parallel to the axis and offset at equal axial distances and uniform angles and which are connected to the receiving bore by connecting slots are arranged around the receiving bore.

2. Collet chuck or clamping sleeve according to claim 1, wherein the collet chuck is slotted and the clearing bores are arranged in each case in the segments formed by the slots.

3. Collet chuck or clamping sleeve according to claim 2, wherein the slots extending from the outer casing radially inwards end at a distance from the receiving bore.

4. Method for the production of a collet chuck according to claim 1, wherein a plurality of clearing bores which are parallel to the axis and offset at equal axial distances and uniform angles are made around the axis, an erosion wire is threaded through one of them and then a connecting slot to the axis, a coaxial receiving bore and from there connecting slots to the further clearing bores are produced in succession.
